(19) United States
(12) Patent Application Publication
(10) Pub. No.: US 2005/0282440 A1
(43) Pub. Date: Dec. 22, 2005

(54) Card connector

(75) Inventors: Gwou Jong Tseng, Tu-Chen (TW); Tien-Chien Su, Tu-chen (TW); Senbing Zhao, Kunsan (CN)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION IND. CO., LTD.

(21) Appl. No.: 11/099,766

(22) Filed: Apr. 5, 2005

(30) Foreign Application Priority Data
Jun. 18, 2004 (TW) 93117598

(51) Int. Cl. H01R 24/00

(52) U.S. Cl. 439/630

(57) ABSTRACT

A card connector (100) for electrically connecting an electrical card (9) includes a housing (1), a number of conductive contacts (2) and an eject mechanism for ejecting out the card received in the housing. The eject mechanism includes slider (51) slidably assembled to the housing and a metal strip (54) fixed to the slider. The metal strip forms a tab portion (543) apart from the slider and two support portions (544,545) flexibly supporting said tab portion. The tab portion forms a tapered latch tab (546) for latching into a notch (90) defined in one edge of the card inserted into the card connector, whereby holding the card in place.

### BACKGROUND OF THE INVENTION

1. Field of the Invention

The present invention relates to a card connector for connecting an integrated circuit card to another electronic device, and more particularly, to a card connector with a compact structure for reliably holding an inserted electrical card.

2. Description of the Prior Art

A conventional card connector is disclosed in Japanese Patent Publication No. 2003-223957. The card connector includes an insulative housing, a number of conductive contacts received in the housing, an eject mechanism to perform a push-push operation and a metal shell covering over the housing. The metal shell and the housing cooperatively define a card-receiving cavity for receiving an electrical card. The eject mechanism includes a slider slidably arranged on one side of the card receiving cavity and a latch means for latching the card when the card is inserted into the card-receiving cavity. The latching means further includes a metal strip having a latch tab protruding into the card-receiving cavity and a metal piece positioned out side of the latch tab for providing enough elasticity to push the latch tab inwardly the card-receiving cavity. Before the card is inserted into the card-receiving cavity, the metal shell compresses the metal piece, so that the latch tab keeps out of the card-receiving cavity and the card is free from the latch means. When the card is pushed fully into the card-receiving cavity, the metal piece is released and pushes the metal strip so that the latch tab gets into a recess defined in one edge of the card and locks the card there. When the outside of the card is pushed another time, the eject mechanism is released and ejects the card outwardly. At the same time, the metal piece is pressed back by the metal shell again, so the latch tab gets out of the recess of the card. In order to drive the latch tab to move as needed, a spring metal piece and some appendix structure in the metal shell is needed, which makes the structure of the card connector complex and the cost of making it increase. Furthermore, the latch means disengages when the card is ejected outwardly, so that the card may be completely out of the card receiving cavity and fall down from the device.

Hence, an improved electrical card connector having a simplified structure is needed to solve the above problems.

### BRIEF SUMMARY OF THE INVENTION

A main object of the present invention is to provide a card connector which is capable of reliably holding an inserted card in a simplified compact mechanism.

Still another object of the present invention is to provide a card connector which has a latch means latching the card when the card is at an inserting position or at an inserted position.

In order to attain the objects above mentioned, a card connector for electrically connecting with an electrical card includes a housing with a plurality of conductive contacts received therein, a metal shell covering over the housing, an eject mechanism and a latch means. The housing and the metal shell cooperatively define a card-receiving cavity for receiving the card. The eject mechanism includes a slider slidably along a side of the card receiving cavity, a coil spring and a cam follower to control the movement of the slider. The latch means includes a metal strip attached to the slider. The metal strip forms two support portions along the strip and a tab portion having a latch tab there between the support portions. The tab portion is apart from the slider and the support portions lean against the slider and flexibly support the tab portion. The latch tab extends into the card-receiving cavity from a side and is tapered in both the insertion and the extraction direction of the card. So the latch means is simplified into a metal strip with two support portions and can supply adequate elasticity to prop up the latch tab into a recess defined in a corresponding edge of the card inserted into the card-receiving cavity. Further more the latch tab keeps in the recess of the card and latching the card when the card is inserted into an inserted position or ejected to an inserting position.

Other objects, advantages and novel features of the invention will become more apparent from the following detailed description of the present embodiment when taken in conjunction with the accompanying drawings.

### BRIEF DESCRIPTION OF THE DRAWINGS

The features of this invention which are believed to be novel are set forth with particularity in the appended claims. The invention, together with its objects and the advantages thereof, may be best understood by reference to the following description taken in conjunction with the accompanying drawings, in which like reference numerals identify like elements in the figures and in which:

FIG. 1 is a perspective view of a card connector of the present invention;

FIG. 2 is a similar view of FIG. 1, but from another perspective view;

FIG. 3 is a perspective view of the card connector with a metal shell is disassembled;

FIG. 4 is a similar view of FIG. 3, but from another perspective view;

FIG. 5 is an exploded view of the card connector;

FIG. 6 is a similar view of FIG. 3, but from another perspective view;

FIG. 7 is a plane view of a card connector of the present invention with a metal shell removed off and an electrical card inserted to an inserting position where the card is partly inserted into the card connector; and

FIG. 8 is a similar view as FIG. 7, except that the card is inserted into an inserted position where the card is fully inserted into the card connector.

### DETAILED DESCRIPTION OF THE INVENTION

Reference will now be made to the drawing figures to describe the present invention in detail.

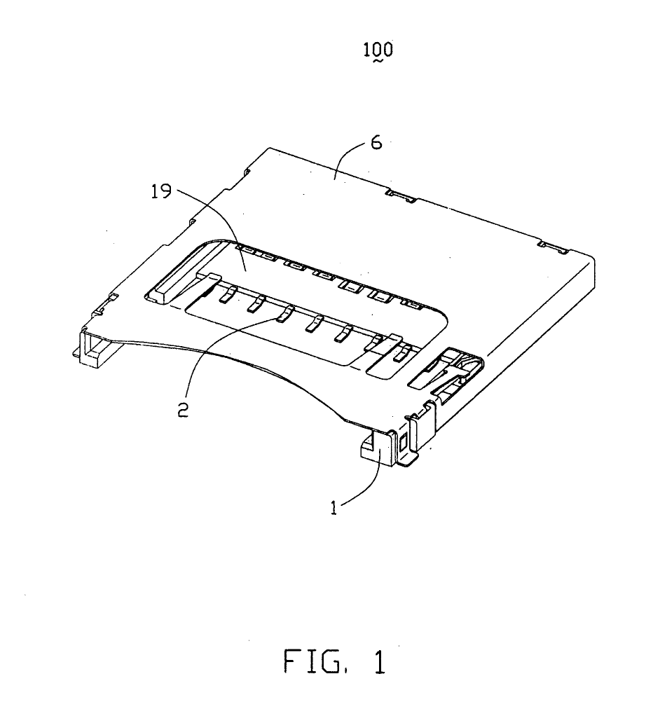

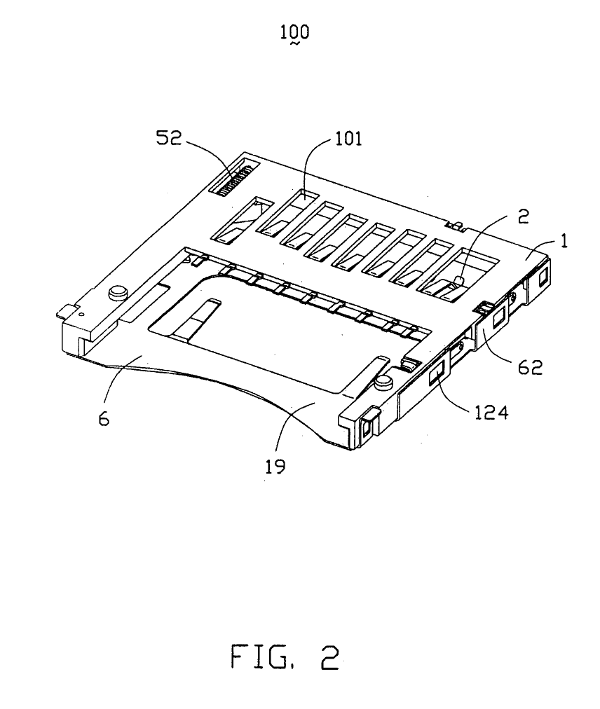

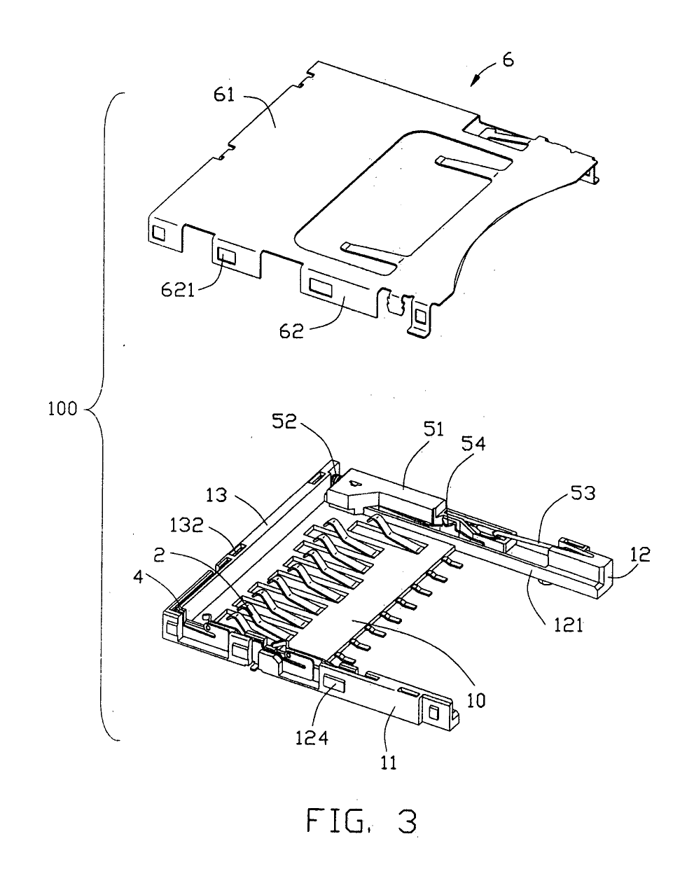

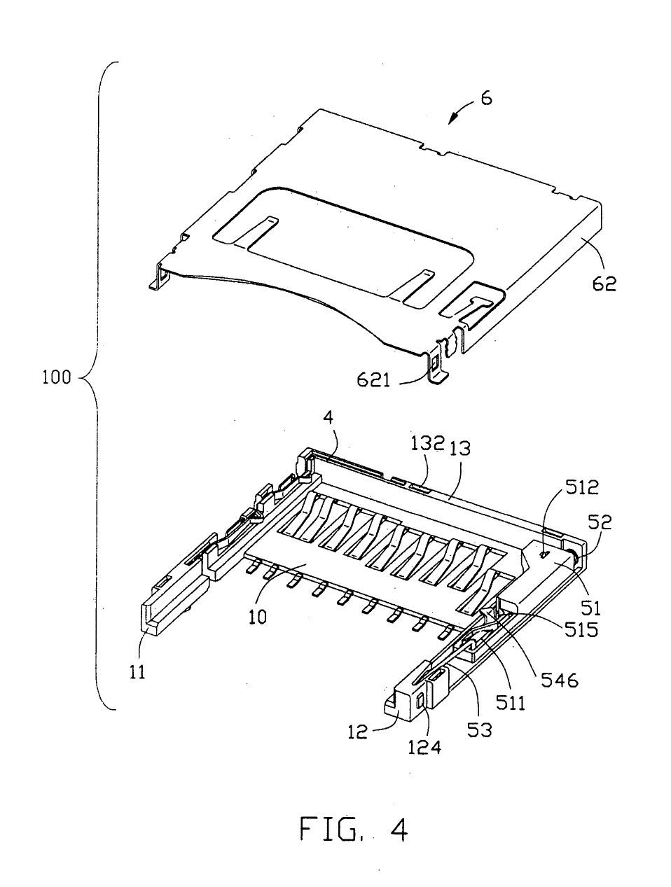

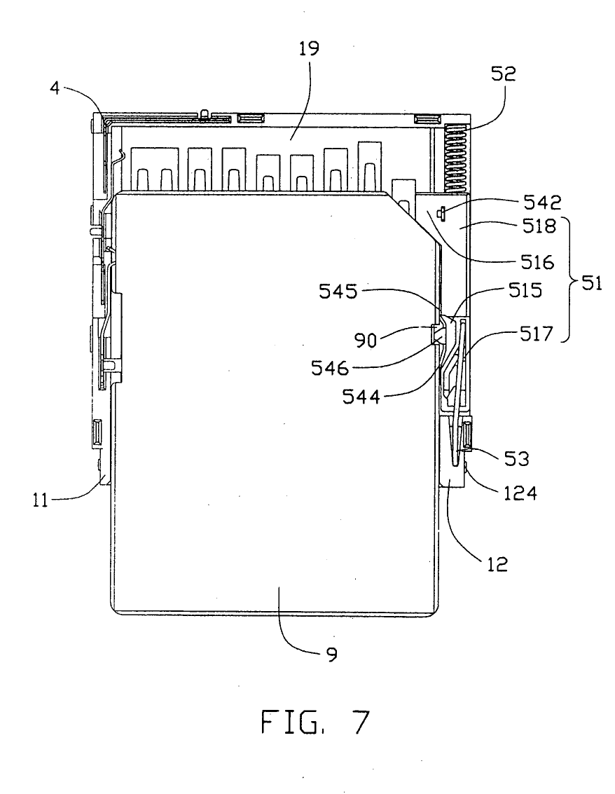

Referring to FIGS. 1-4, a card connector 100 for electrically connecting an electrical card 9 (shown in FIG. 7) to an electrical device (not shown) according to the present invention is shown. The card connector 100 includes an insulative housing 1, a plurality of conductive contacts 2, a pair of detecting contacts 3, and a written proof member 4, an eject mechanism (not labeled) and a metal shell 6 covering the housing 1.

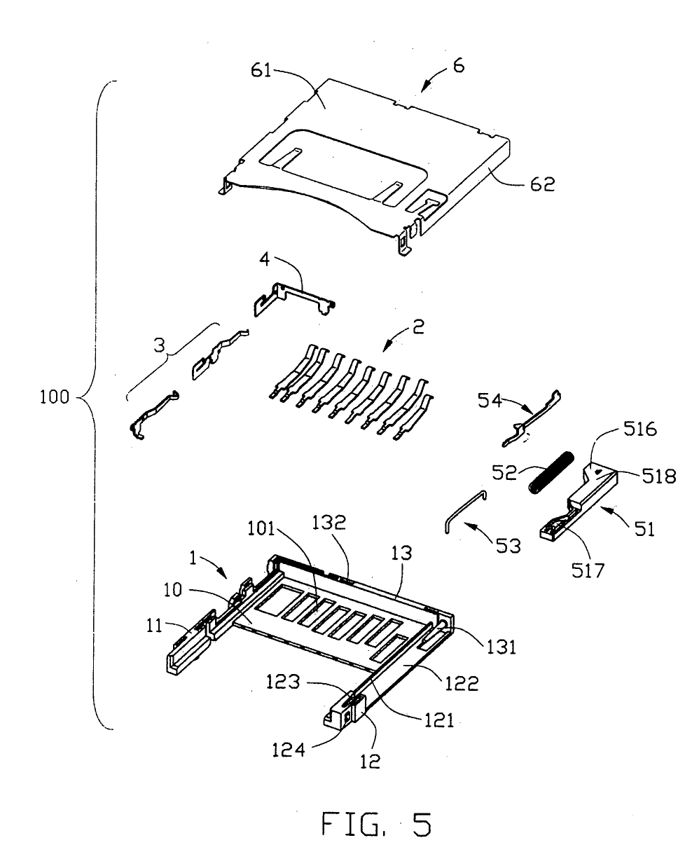

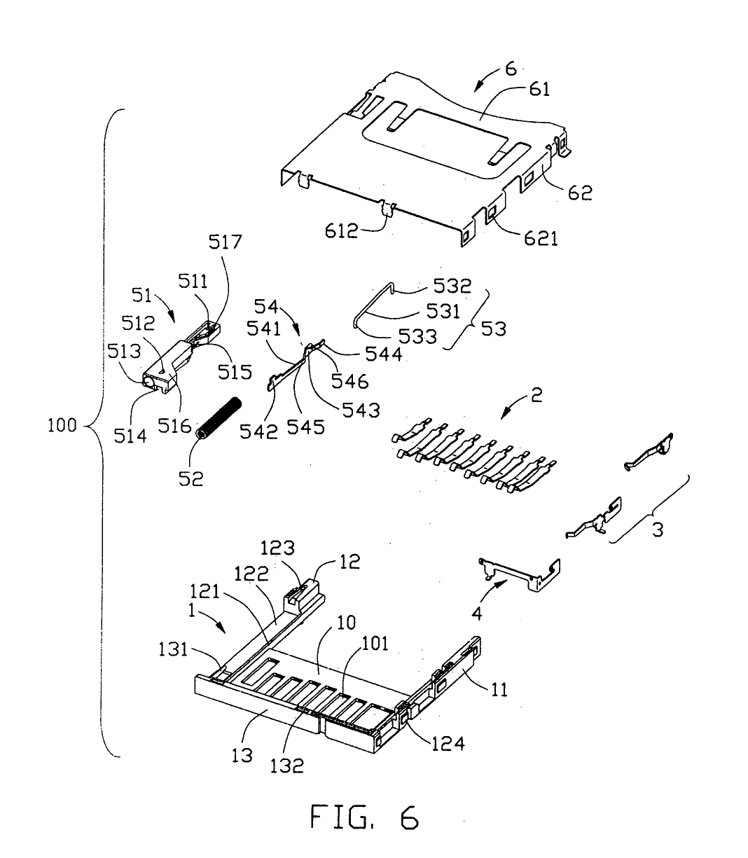

FIGS. 5 and 6 are exploded views of the card connector 100, in which the housing 1 is separated from the other components of the card connector 100. The housing 1 comprises a bottom wall 10, a pair of sidewalls 11,12 parallel arranged along two opposite edges of the bottom wall 10 and a rear wall 13 connecting the sidewalls 11,12, which cooperates with the metal shell 6 to define a card receiving cavity 19 for receiving the card 9. The bottom wall 10 defines a plurality of contact receiving channels 101 for receiving the conductive contacts 2. The sidewall 12 comprises a cavity 122 for the receiving the eject mechanism, a guiding rib 121 and a pivot hole 123. Furthermore, outsides of the sidewalls 11,12 form a plurality of blocks 124 for engaging with the metal shell 6. The rear wall 13 has a pair of securing holes 132 in a top face and a fixing pole 131 protruding forwardly into the cavity 122.

The eject mechanism comprises a slider 51, a cam follower 53, a coil spring 52 and a latch means 54 fixed to the slider 51. The slider 51 is substantially L-shaped and includes a body portion 518, an abutment 516 transversely extending from a rear end of the body portion 518, and a guiding portion 517 extending forwardly from a front end of the body portion 518. The body portion 518 defines a guiding slot 514 opening downwardly, a securing hole 512 in the guiding slot 514 and a circular hole 513 opening backwardly. The guiding portion 517 defines a heart-shaped and upwardly opening guiding groove 511. The slider 51 further defines a concavity 515 communicating an end of the guiding slot 514. The cam follower 53 comprises a rod 531 and two pin members 532,533 perpendicularly connected to two opposite ends of the rod 531.

The latch means 54 is substantially a metal strip in a preferred embodiment. The latch means 54 includes a straight portion 541, two support portions 544,545, and a tab portion 543 having a latch tab positioned between the support portions 544,545. The straight portion 541 connects the support potion 544 at one end and forms an ear 542 extending upwardly at an opposite end. The latch tab 546 tapered in both the insertion and the extraction directions of the card 9 for facilitating inserting and extracting of the card 9.

The metal shell 6 comprises a plate 61 and several bent portions 62. Some of the bent portions 62 are securing fingers 612 formed with thorns for being retainably received in securing holes 132, some others are formed with windows 621 to get stuck with the blocks 124 of the sidewalls 11,12.

In assembly of the card connector 100, the conductive contacts 2 are integrally formed with the housing 1, such as by insert-molding. The detecting contacts 3 and the written proof member 4 are inserted in grooves (not labeled) defined in the sidewall 11 and rear wall 13 of the housing 1. The latch means 54 are arranged in the guiding slot 514 of the slider 51 with the ear 542 inserted into the securing hole 512 and the straight portion 541 of the latch means 54 along a side of guiding slot 514. The support portions 544,545 biases against opposite sides of the concavity 515, whereby support the tab portion apart from the bottom of the concavity 515 and the latch tab protruding into the card-receiving cavity. The two support portions can provide adequate elasticity to drive the latch tab 546 into and keep it in the recess 90 of the card 9 when the card is inserted in. The coil spring 52 is put into the circular hole 513 of the slider 51. The combination of the slider 51, the coil spring 52 and the latch means 54 is assembled in the cavity 122 of the housing 1 with the guiding rib 121 received in the guiding slot 514 and the fixing pole 131 sheathed by the coil spring 52. The slider 51 is pushed to a front position by the coil spring 52. The latch tab 546 protrudes into the card-receiving cavity 19. The pin member 532 of the cam follower 53 rotatablely fits into the pivot hole 123 of the housing 1 and the other pin member 533 slidably fits into the guiding groove 511. The metal shell 6 is set over the housing 1 with the securing fingers 612 inserted into securing holes 132 and the windows 621 getting stuck with the blocks 124 on the outsides of the sidewalls 11,12.

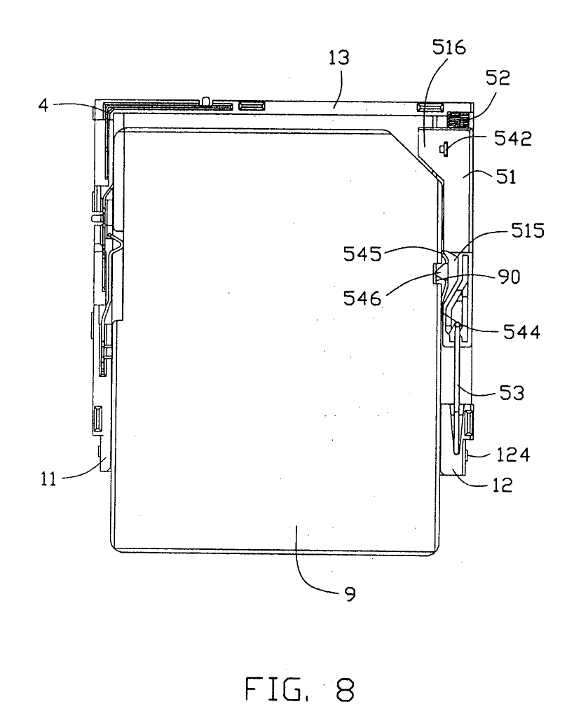

Referring to FIG. 7, the card 9 is partly inserted into the card connector 100 to an inserting portion where the card 9 firstly touches the abutment 516. Before the card 9 reaches the inserting position, the latch tab 546 is pressed out from the card-receiving cavity 19 by the card 9 and the tab portion 543 is driven into the concavity 515. When the card 9 reaches the inserting position, the latch tab 546 slips flexibly into a recess 90 defined in a corresponding edge of the card 9 under the elasticity from the support portions 544,545. At the same time, a front edge of the card 9 abuts the abutment 516 of the slider 51. Referring to FIG. 8, after the card 9 is pushed a first time, the card 9 reaches an inserted position where the card 9 is communicated electrically to the electrical device. When the card 9 moves toward the inserted position, it pushes slider 51 to a rear position and the slider 51 compresses the coil spring 52. When the card 9 reaches the inserted position, the cam follower 53 locks the eject mechanism and prevents slider 51 from moving toward the front position under the spring force of coil spring 52.

When the card 9 is pushed rearward a second time, the eject mechanism is released and the slider 51 is pushed forwardly by the coil spring 52, whereby the abutment 516 ejects the card 9 outward the card receiving cavity 19 to the inserting position. When in above process of double push, the latch means 54 keeps moving with the slider 51 and the card 9, so that the latch tab 546 keeps in the recess 90 and latches the card 9 in respective positions. Lately, when the card 9 is drawn back from the inserting position, an edge of the card 9 slides along the tapered face of the latch tab 546 and presses the latch tab 546 outwardly from the card receiving cavity 19, so that the latch means is released for facilitating being drawn back of the card 9.

It is to be understood, however, that even though numerous, characteristics and advantages of the present invention have been set fourth in the foregoing description, together with details of the structure and function of the invention, the disclosed is illustrative only, and changes may be made in detail, especially in matters of number, shape, size, and arrangement of parts within the principles of the invention to the full extent indicated by the broad general meaning of the terms in which the appended claims are expressed.

1. A card connector for electrically connecting with an electrical card defining a notch in one edge thereof, comprising:
a housing with a plurality of conductive contacts received therein;
a metal shell cooperating with said housing to define a card receiving cavity for receiving said electrical card; and
an eject mechanism assembled to said housing, comprising:
a slider slidably along an insertion direction or an extraction direction in the metal shell and arranged on one side of said card receiving cavity; and
a metal strip fixed to the slider, said metal strip forming a crook portion, said crook portion forming two support portions and a tab portion having a latch tab between said support portions, the support portions abutting said slider for flexibly biasing said tab portion, the latch tab flexibly slipping into a notch defined in the card when the card is inserted into said card receiving cavity, the latch tab further being tapered in both the insertion direction and the extraction direction for facilitating the inserting and the withdrawing of said card.

2. The card connector according to claim 1, wherein the housing forms a guiding rib, and wherein the slider defines a guiding slot slidablely along the guiding slot.

3. The card connector according to claim 2, wherein the metal strip further forms a straight portion connected to the crook portion, the straight portion arranged along a side of the guiding slot.

4. The card connector according to claim 1, wherein the straight portion of the metal strip forms an end and the end further forms an ear, the slider defining a hole in the guiding slot, the ear fitting into the hole to fix the metal strip to the slider.

5. The card connector according to claim 1, wherein the slider defines a concavity on the outside of said metal strip for receiving the tab portion when the latch tab is pressed outward from the card receiving cavity by an inserted card.

6. The card connector according to claim 5, wherein the eject mechanism further comprises a cam follower and a coil spring for controlling the movement of the slider.

7. The card connector according to claim 1, wherein the slider defines a guiding groove and the cam follower includes a rod and two opposite bends, one bend slidably fitting in the guiding groove and the other bend rotatablely fitting in a pivot hole defined in the housing.

8. An eject mechanism used in a card connector which defining a card receiving cavity for an electrical card to be inserted in, the eject mechanism comprising:
a slider slidably arranged on one side of the card receiving cavity adapted to move in a card insertion direction as the card is inserted into the card connector and to move in a card extraction direction in response to a card eject operation to eject the card;
a coil spring for driving the slider to move along the card extraction direction;
a cam follower for locking the slider when the card is fully inserted into the card receiving cavity; and
a latch means fixed to the slider, said latch means forming a crook portion arranged on one side of the card receiving cavity, said crook portion forming two support portions and disposed between the support portions, said support portion standing against the slider and flexibly biasing said tab portion apart from the slider, the tab portion forming a latch tab extending into the card receiving cavity for latching said card when the card is inserted into the card receiving cavity, the latch tab further forming two tapered faces in both the insertion direction and the extraction direction of the card thereby facilitating the insertion and the extraction of said card.

9. The eject mechanism according to claim 9, wherein the slider defines a guiding slot for guiding the movement of the slider in the card connector, said latch means forming a straight portion having an end connected to the crook portion, said straight portion arranged alongside the guiding slot.

10. The eject mechanism according to claim 10, wherein the straight portion of the latch means forms an end opposite to the crook portion, said end having a ear protruding upwardly, the slider defining a hole in the guiding slot, and wherein the ear is inserted into the hole, whereby fixing the latch means to the slider.

11. The eject mechanism according to claim 9, wherein the slider defines a concavity on the outside of the latch means for receiving the tab portion when the latch tab is pressed out from the card receiving cavity by an inserted card.

12. A card connector assembly comprising:
an electrical card;
a housing with a plurality of conductive contacts received therein;
a metal shell cooperating with said housing to define a card receiving cavity receiving said electrical card; and
an eject mechanism assembled to said housing, comprising:
a slider slidably along an insertion direction or an extraction direction in the metal shell and arranged by one side of said card receiving cavity; and
a metal strip fixed to the slider, said metal strip forming a crook portion, said crook portion forming two support portions and a tab portion having a latch tab between said support portions, the support portions abutting said slider for flexibly biasing said tab portion, the latch tab flexibly slipping into a notch defined in the card when the card is inserted into said card receiving cavity, the latch tab further being tapered in both the insertion direction and the extraction direction for facilitating the inserting and the withdrawing of said card.

13. The assembly according to claim 12, wherein the slider defines a concavity to accommodate lateral deflection of the metal strip.
